(19) United States
(12) Patent Application Publication
(10) Pub. No.: US 2017/0288470 A1
(43) Pub. Date: Oct. 5, 2017

(54) LOAD BALANCING AND SCHEDULING IN WIRELESS POWER TRANSFER NETWORK

(71) Applicant: Intel Corporation, Santa Clara, CA (US)

(72) Inventors: Hooman Shirani-Mehr, Portland, OR (US); Ahmad Farbod Khoshnevis, Portland, OR (US); Xintian E. Lin, Mountain View, CA (US); Sreenivas Kasturi, Hillsboro, OR (US)

(21) Appl. No.: 15/087,632

(22) Filed: Mar. 31, 2016

(51) Int. Cl. H02J 50/80; H02J 7/02

(52) U.S. Cl. CPC H02J 50/80; H02J 7/025

(57) ABSTRACT

Methods and apparatus for load balancing and scheduling in wireless power transfer networks are disclosed. An example method includes receiving data related to a power receiving unit (PRU) from a first power transmitting unit (PTU), identifying a second PTU based on the data, and transmitting an alert corresponding to the second PTU to at least one of the first PRU, the first PTU, the second PTU, or a display.

### FIELD OF THE DISCLOSURE

This disclosure relates generally to wireless power transfer and, more particularly, to methods and apparatus for load balancing and scheduling in wireless power transfer networks.

### BACKGROUND

Wireless charging stations have grown in popularity over the past few years. Wireless power stations are now more readily available to wirelessly charge computing devices (e.g., laptops, mobile devices, tablets, etc.). A wireless charging station has a limited number of power resources to provide power to (e.g., charge) a limited number of computing devices. After the limit of a wireless charging station is reached, additional computing devices are unable to receive power from the charging device until one of the currently charging computing devices leaves the vicinity of the wireless charging station.

### BRIEF DESCRIPTION OF THE DRAWINGS

FIG. 1 is an example illustration of an environment to balance and schedule loads in a wireless power transfer network.

FIG. 2 is an example illustration of the transmission gateway of FIG. 1 used herein to balance and schedule loads of a wireless power transfer network.

FIG. 3 is a block diagram of an example of the load identifier of FIG. 2.

FIG. 4 is a block diagram of an example of the load balancer of FIG. 2.

FIGS. 5-6 are flowcharts representative of example machine readable instructions that may be executed to implement the example load identifier of FIG. 3.

FIGS. 7-8 are flowcharts representative of example machine readable instructions that may be executed to implement the example load balancer of FIG. 4.

FIG. 9 is a block diagram of a processor platform structured to execute the example machine readable instructions of FIGS. 5-6 to implement the example load identifier of FIG. 3.

FIG. 10 is a block diagram of a processor platform structured to execute the example machine readable instructions of FIGS. 7-8 to implement the example load balancer of FIG. 4.

The figures are not to scale. Wherever possible, the same reference numbers will be used throughout the drawing(s) and accompanying written description to refer to the same or like parts.

### DETAILED DESCRIPTION

A wireless charging station is an electrical device that includes a power transmitting unit (PTU) (e.g., a transmitter) to provide power to charge one or more electronic (e.g., computing) devices with power receiving units (PRUs) (e.g., receivers). For example, a PRU of an electronic device outputs an advertisement (e.g. a wireless signal) to establish a communication and power connection with a charging station. If the computing device is within range of a power signal associated with a PTU of a wireless charging station, the example PTU establishes a communication connection (e.g., communication link) between the PTU and the PRU while the computing device receives the power signal via a power connection (e.g., link). A power signal provides power to (e.g., charges) the computing device via the PRU. The PRU and/or the PTU can exchange data via the communication link.

At some locations, multiple wireless charging stations may be utilized to maximize the total wireless charging area. For example, a table(s) at a coffee shop may include two or more wireless charging stations equally, or unequally, spread throughout the table(s). In such an example, a PRU of a computing device can communicate with and receive power from any one of the PTUs of the wireless charging stations. Due to hardware and/or software limitations of the PTUs, PTUs can only provide power to a limited number of computing devices at a time. Further, a PTU can only provide power to computing devices of a lessor or equal class. A class is associated with the amount of power drawn (e.g., load) associated with the computing devices. For example, a smart phone may have a class of three and a laptop may have a class of five. In such an example, a class three PTU can provide power to the smart phone, but not the laptop. In some examples, a PRU attempts to establish a connection to receive power from a PTU that is full. As used herein, a PTU that is providing power to the maximum number of PRUs (e.g., due to the hardware and/or software limitations of the PTU) is herein referred to as “full.” As used herein, a PTU that is not providing power to the maximum number or PRUs is herein referred to as “available.” A full PTU has insufficient power resources to power an additional PRU and an available PTU has sufficient power resources to power the additional PRU. When a PRU attempts to receive power from a conventional PTU that is full, the PTU alerts the PRU that the PTU is currently unavailable. Conventional PTUs do not identify and/or alert a user to the location of available PTUs because conventional PTUs operate independently.

Examples disclosed herein utilize a transmission gateway to generate a mapping of PTUs including data related to operation of the PTUs (e.g., a topology mapping). The topology mapping includes data corresponding to the availability of PTUs in the network. A PTU in the network may transmit data related to a status of the PTU to the transmission gateway to generate and/or update the topology mapping. The PTU data may include an identifier of the PTU, a class of the PTU, a power of the PTU, a maximum power of the PTU, a timestamp, a status of the PTU (e.g., how many and/or which PRUs are connected to the PTU), a location of the PTU, and/or any data related to the PTU.

When a PRU attempts to receive power from a full PTU, the PTU sends data corresponding to the PRU to the transmission gateway. The PRU data may include an identifier of the PRU, a device type of the PRU, a timestamp, a class of the PRU, a power of the PRU, a status of the PRU, a location of the PRU, and/or any data related to the PRU. The transmission gateway identifies an available PTU(s) in the topology mapping based on the PTU and/or PRU data and transmits an alert to a user of the computing device to identify the available PTU(s). The alert may be audio, video, an image, text, symbols, and/or a light used on a display to identify a location of the available PTU. The alert may be transmitted to one or more of the PTUs and/or a display. Additionally or alternatively, the alert may be transmitted to the PRU. The computing device associated with the PRU may execute instructs based on the alert to display available PTU data directly to the user. Alternatively, two PTUs may be directly connected and a transmission gateway may not be required. For example, when a PRU attempts to receive power from a full PTU in a two-PTU system, the first PTU may communicate with a second PTU to identify whether the second PTU is available. If the second PTU is available an alert may be transmitted to the PRU, the second PTU, and/or a display connected to the PTUs.

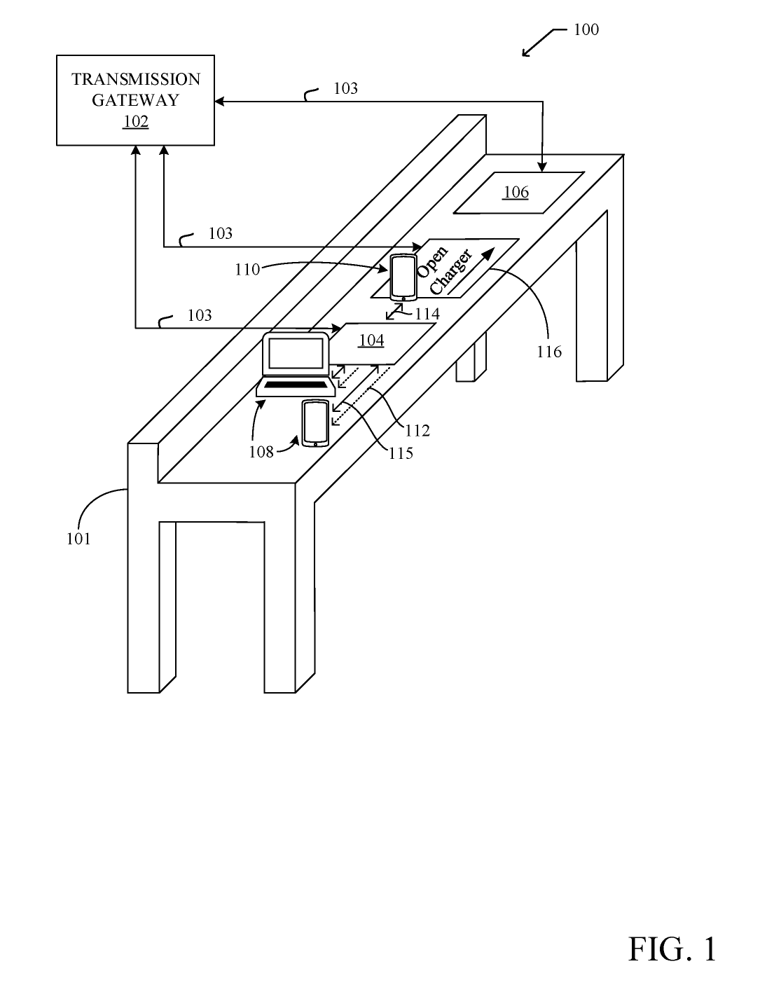

FIG. 1 is an example environment 100 illustrating a wireless power transfer network with an example transmission gateway 102 communicating with two example PTUs (e.g., charging stations) 104, 106. For example, the example environment 100 may include the example table 101 in a public environment that includes two or more PTUs. Although the example environment 100 includes the example table 101 with two PTUs, any number/type of structures with any number of PTUs may be utilized. The example environment 100 includes the example transmission gateway 102, an example gateway link 103, a first example PTU 104, a second example PTU 106, example computing devices 108, 110, an example power link 112, example communication links 114, 115, and an example display 116.

In the example environment 100 of FIG. 1, the example transmission gateway 102 is a networking device that wirelessly communicates with and/or powers various computing devices and balances loads associated with the example PTUs 104, 106. Alternatively, the example transmission gateway 102 may be any computing device (e.g., a tablet, a mobile device, a portable computing device, a processor, a gaming system, a server, and/or any type of computing device). The transmission gateway 102 facilitates communication between connected PTUs (e.g., the example PTUs 104, 106) via the example gateway link 103 to develop and maintain load conditions of the example PTUs 104, 106 in the network topology. The example gateway link 103 may be a wired (e.g., universal serial bus (USB), Ethernet, etc.), or wireless (e.g., Wi-Fi, ZigBee, Bluetooth, radio frequency identifier, near field communication, etc.), connection used to communicate data between the example transmission gateway 102 and the example PTUs 104, 106.

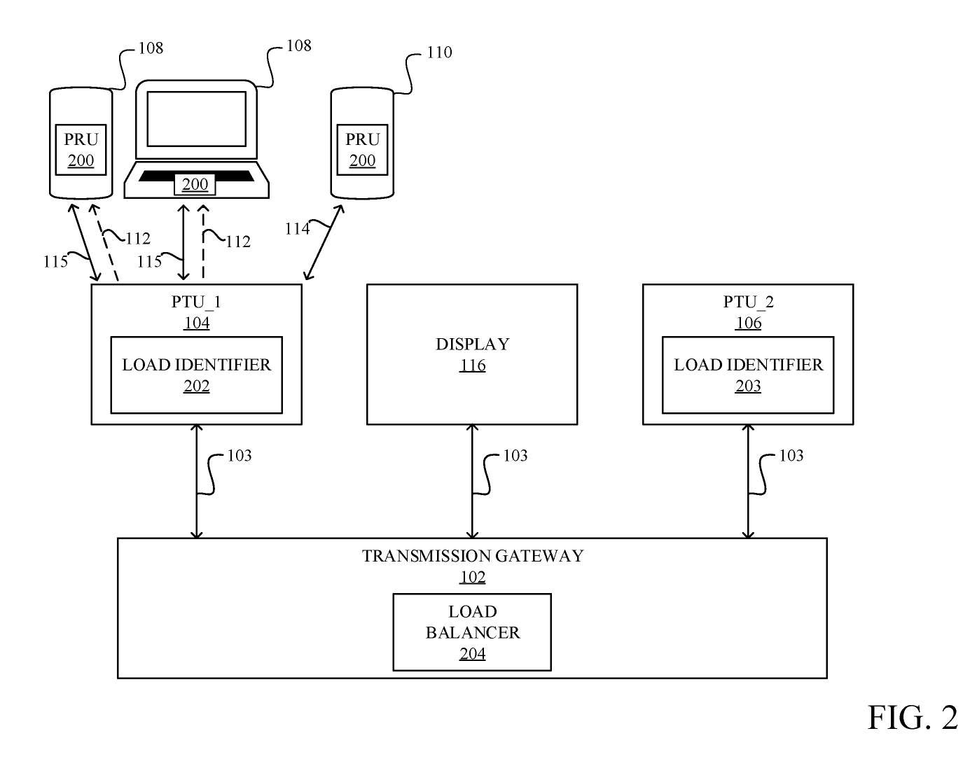

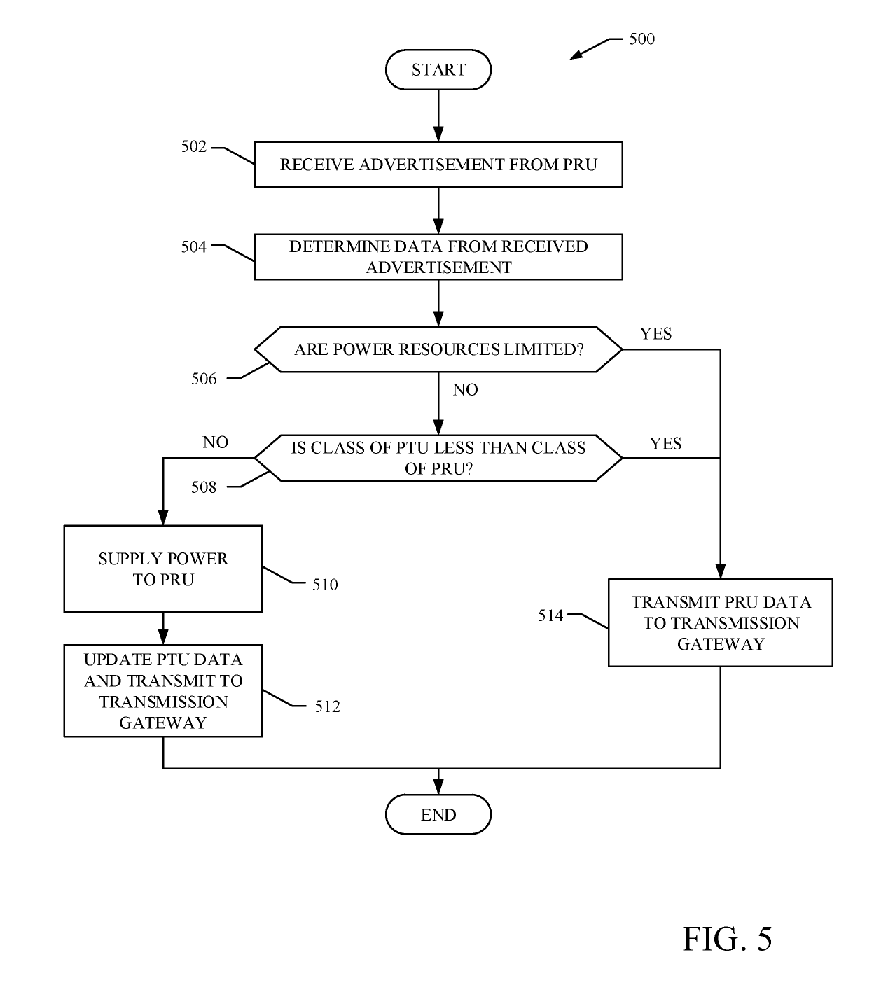

The example PTUs 104, 106 are power transmission units. The example PTUs 104, 106 may be employed using any standard. For example, the example PTUS 104, 106 may be employed using an Alliance for Wireless Power (A4WP) standard, a Power Matter Alliance (PMA) standard, an AirFuel Alliance standard, a PowerMergerCo standard, and/or any other standard of PTU capable of powering more than one computing device. The example PTUs 104, 106 include an antenna and/or a coil to generate electromagnetic waves to communicate with PRUs via the example communication links 114, 115 and/or generate the power signals via the example power links 112. The power signals are received by PRUs (e.g., embedded in, or otherwise connected to, the example computing devices 108, 110) to power (e.g., charge) the example computing devices 108, 110. The example communication links 114, 115 are used to communicate with the PRUs of the computing devices 108, 110. As further described in FIGS. 2 and 5, the example PTUs 104, 106 communicate with PRUs and the example transmission gateway 102. For example, PTUs 104, 106 may communicate PTU data and/or PRU data to the example transmission gateway 102. The PTU data may include an identifier of the PTU, a class of the PTU, a power of the PTU, a maximum power of the PTU, a timestamp of the PTU, a status of the PTU (e.g., how many and/or which PRUs are connected to the PTU), a location of the PTU, and/or any data related to the PTU. The PRU data may include an identifier of the PRU, a device type of the PRU, a timestamp, a class of the PRU, a power of the PRU, a status of the PRU, a location of the PRU, and/or any data related to the PRU. In some examples, the first example PTU 104 and the second PTU 106 are connected via a wired or wireless link.

The example computing devices 108, 110 include PRUs capable of receiving wireless power from the example PTUs 104, 106 via the example power link 112 to charge a battery of the computing devices 108, 110. The example computing devices 108, 110 may be mobile devices, smartphones, computers, laptops, tablets, media players, portable gaming devices, digital media recorders, and/or any other type of computing device with a PRU embedded in, or otherwise connected to, the computing device. As previously described, when any one of the example computing devices 108, 110 enters within a threshold range of either one of the example PTUs 104, 106, the computing device 108, 110 may receive power and/or communicate with at least one of the example PTUs 104, 106. Although the example environment 100 includes three computing devices, any number of computing devices may be powered by and/or communicate with any one of the example PTUs 104, 106.

The example power link 112 includes an electromagnetic wave output by the example PTUs 106, 104. The example power link 112 provides power to the example computing devices 108, 110. The example communication links 114, 115 are wireless links to wireless exchange data between the example PTUs 104, 106 and the example computing devices 108, 110. The example communication links 114, 115 may be a Bluetooth low energy (BLE) link, a Wi-Fi link, a near field communication link, a wireless universal serial bus link, a radio frequency identification link, and/or any other type of wireless link).

The example display 116 is an electrical device capable of outputting data (e.g., text, picture, video, audio, etc.). The example display 116 can be implemented, for example, by display devices (e.g., a light emitting diode (LED), an organic light emitting diode (OLED), a liquid crystal display, a cathode ray tube display (CRT), a touchscreen, a tactile output device, and/or speakers). In some examples, the example display 116 includes a graphics driver card, a graphics driver chip or a graphics driver processor. In some examples, the example display 116 includes a speaker and/or soundcard.

In operation, the example PTUs 104, 106 transmit PTU data to the example transmission gateway 102 via the gateway link 103. The example PTUs 104,106 may periodically (e.g., every N seconds) or aperiodically (e.g., when a new PRU comes within a power and/or BLE range of the either one of the example PRUs 104, 106) transmit PTU data to the example transmission gateway 102.

In response to receiving the PTU data, the example transmission gateway 102 generates a topology mapping of connected PTUs (e.g., the example PTUs 104, 106). The example transmission gateway 102 generates a PTU topology mapping based on the received PTU data. For example, in the illustrated example environment 100, the transmission gateway 102 may determine that, based on the PTU data of the first example PTU 104, power resources of the first example PTU 104 are low. The determination may be based on a number and/or type of the example computing devices 108 that are being powered by the first PTU 104. Alternatively, the first example PTU 104 may include power resource data, an amount of available power resources, and/or a load associated with the PTU 104 in the PTU data. In such examples, the transmission gateway 102 determines the available power resources directly from the PTU data. In the example environment 100, the transmission gateway 102 may determine that the power resources of the first example PTU 104 are low and the power resources of the second PTU 106 are high because the second PTU 106 is not currently powering any computing devices 108, 110.

When the example computing device 110 gets within range of the first example PTU 104, a PRU of the example computing device 110 transmits an advertisement to the first PTU 104. The advertisement establishes the communication link 114, 115 to transmit PRU data and/or request power from the first example PTU 104. When the power resources of the first example PTU 104 are not low, the first PTU 104 establishes a power connection (e.g., the power link 112) to power the example computing device 110. In some examples, the first PTU 104 may transmits PTU data to the example transmission gateway 102 to indicate a change in the power resources based on the new power connection.

When the power resources of the first example PTU 104 are low (e.g., because the first PTU 104 is powering the computing devices 108), the PTU 104 transmits the PRU data to the transmission gateway 102. Alternatively, the first example PTU 104 may transmit the PRU data directly to the second example PTU 106. The transmission gateway 102 processes the PRU data to identify an available PTU(s) to provide power to the example computing device 104. In some examples, the transmission gateway 102 analyses data of the generated topology mapping to identify a PRU with enough power resources to power the example computing device 110. In some examples, the example computing device 110 may be a larger computing device with a higher class associated with a larger load (e.g., a laptop). In such examples, the transmission gateway 102 may identify a PRU with a class high enough to power such a computing device. In some examples, the PTU may transmit a prompt to the PRU of the computing device 110 when the power resources of the first example PTU 104 are low. The prompt may prompt a user of the computing device 110 to identify various preferences. For example, the preferences may include a preferred location of an available charging station. The example transmission gateway 102 selects an available PTU(s) (e.g., the second example PTU 106) based on the available resources of the PTUs in the topology, the PRU data, and/or any other preferences.

When no PTUs are available to power the example PRU 200, the example transmission gateway 102 transmits unavailable instructions to the example display 116. The instructions cause the display 116 to output a message indicating that there are no PTUs available to power the example computing device 110. Additionally or alternatively, the example transmission gateway 102 may send instructions to the first example PTU 104. The instructions may cause the first example PTU 104 to output an indication on a display of the first PTU 104 that there are no PTUs available. Additionally or alternatively, the instructions may cause the first example PTU 104 to transmit a signal to the example computing device 110.

When there is an available PTU(s) (e.g., the second example PTU 106), the example transmission gateway 102 may transmit instructions to the example display 116. The instructions may cause the display 116 to output a message including data related to the location of the example PTU 106. For example, the example display 116 may include a message, an arrow, and/or any other indicator associated with the location of the second example PTU 106. In some examples, the selected PTU may be located in another location (e.g., another table, another room, etc.). In such examples, the example display 116 may include text and/or other data to alert the user of the example computing device 110 where an available PTU(s) is located. In some examples, the display 116 may include a speaker to output a sound to indicate a location of an available PTU(s) to the user. Additionally or alternatively, the example transmission gateway 102 may transmit instructions to the first example PTU 104 and/or the second example PTU 106. The instructions may cause a display of the first PTU 104 and/or the second PTU 106 to output an indication of an available PTU(s). For example, the display of the first example PTU 104 may output an arrow towards the second example PTU 106 and/or the display of the second example PTU 106 may flash on and off to indicate that the PTU 106 is available. In some examples, the first example PTU 104 may send a signal to the PRU 200 of the computing device 110 via the example communication link 114 with data related to the location of the available PRU (e.g., the second PRU 106). In some examples, the transmission gateway 102 may send instructions to any combination of the first PTU 104, the second PTU 106, the computing device 110 (e.g., via the first PTU 104), and the display 116.

FIG. 2 is an illustration of the computing device 110 attempting to receive power from the example PTU 104 of FIG. 1. FIG. 2 includes the example transmission gateway 102, the example gateway link 103, the first example PTU 104, the second example PTU 106, the example computing devices 108, 110, the example power link 112, and the example communication links 114, 115 of FIG. 1. The example computing devices 108, 110 include an example PRU 200, the example PTUs 104, 106 include an example load identifiers 202, 203, and the example transmission gateway 102 includes an example load balancer 204.

The example PRU 200 is an electrical circuit embedded in, or otherwise connected to, the example computing device 110. The example PRU 200 may be employed using any standard. For example, the example PRU 200 may be employed by an A4WP standard, a PMA standard, an AirFuel Alliance standard, a PowerMergerCo standard, and/or any other standard. The example PRU 200 receives data via communication links (e.g., the example communication links 114, 115) and/or the example power links 112 from the first example PTU 104. The example PRU 200 may include an antenna and/or coil to receive a power signal via the power link 112. Additionally, the example PRU 200 transmits data to the first example PTU 104 via the communication link 114. The transmitted data may include instructions, requests, responses, commands, etc. and/or PRU data.

The example load identifiers 202, 203 identify load conditions of the example PTU 104, 106. The example load identifiers 202, 203 communicate with and/or provide power to the example PRUs 200 of the example computing devices 108, 110. Additionally, the example load identifiers 202, 203 transmit PTU data to the transmission gateway 102. As described above, the PTU data may include an identifier of the PTU, a class of the PTU, a power of the PTU, a maximum power of the PTU, a timestamp of the PTU, a status of the PTU (e.g., how many and/or which PRUs are connected to the PTU), a location of the PTU, and/or any data related to the PTU. When power resources are low (e.g., the load is high) and a PRU (e.g., the example PRU 200 of the example computing device 110) attempts to receive power from the first example PTU 104, the example load identifier 202 transmits PRU data to the example transmission gateway 102. In some examples, the first load identifier 202 may communicate PRU data directly to the second load identifier 203. The PRU data may include an identifier of the PRU, a device type of the PRU, a timestamp, a class of the PRU, a power of the PRU, a status of the PRU, a location of the PRU, and/or any data related to the PRU. In some examples, the load identifiers 202, 203 receive instructions from the example transmission gateway 102. Alternatively, the first load identifier 202 may receive instructions from the second load identifier 203 and vice versa. The instructions received by the example load identifier 202 may include generating and/or transmitting a signal to the PRU 200. In such examples, the load identifier 202 generates and/or transmits the signal to the PRU 200 based on the instructions. Additionally or alternatively, the instructions may identify an alert to be output by a display of the first example PTU 104 and/or the second example PTU 106. In such examples, the display may execute the instructions to output the alert.

The example load balancer 204 generates and manages a topology mapping of PTU devices in a network topology. In some examples, the load balancer 204 updates the topology mapping when additional PTU data is received. In some examples, the load balancer 204 instructs the example PTUs 104, 106 to transmit updated PTU data. When the example load balancer 204 receives PRU data (e.g., associated with the example PRU 200 of the example computing device 110) from a PTU (e.g., the first example PTU 104), the load balancer 204 determines that status of the PTUs 104, 106 in the topology mapping to find a PTU (e.g., the second example PTU 106) available to power the example PRU 200 of the example computing device 110. The example load balancer 204 selects the second example PTU 106 because there are no computing devices receiving power from the second example PTU 106 (e.g., the power resources of the second example PTU 106 are high and the load is low).

The load balancer 204 further selects an available PTU (e.g., the second PTU 106) based on a class associated with the second PTU 106 and the class associated with the example PRU 200. For example, if the example computing device 110 is a class three device (e.g., a smart phone) and the second example PTU 106 is a class four device (e.g., able to power classes 1-4), then the example load balancer 204 determines that the second example PTU 106 is able to power the example computing device 110. If, however, the example computing device 110 is a class five device (e.g., a laptop), the second example PTU 106 is not able to power the computing device 110. Thus, the example load balancer 204 will not select the second example PTU 106 and may select for another available PTU in the topology based on the mapping. Additionally or alternatively, the PRU data may include user preferences corresponding to user preferred locations. In such examples, the load balancer 204 may select an available PTU based, in part, on the user preferences. Once the example load balancer 204 selects a PTU (e.g., the second example PTU 106), the load balancer 204 sends instructions to at least one of the first example PTU 104, the second example PTU 106, the example display 116, and/or the example PRU 200 of the computing device 110 (e.g., via the first example PTU 104). The instructions may include data relating to alerting the example PRU 200 of the example computing device 110 that the first example PTU 104 is unavailable and/or the second example PTU 106 is available.

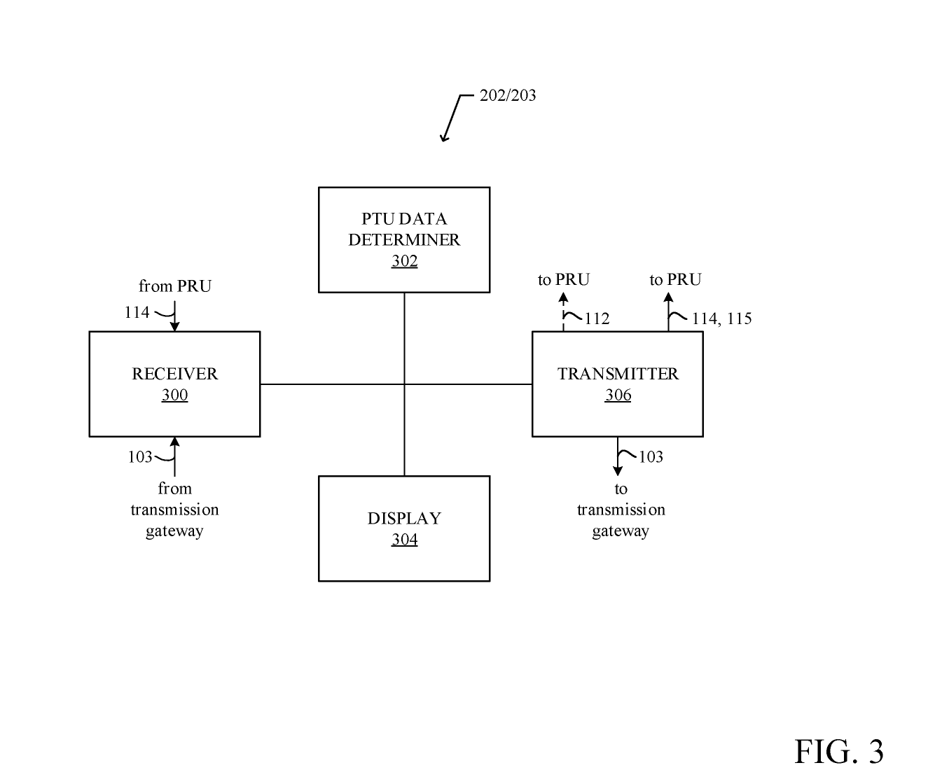

FIG. 3 is a block diagram of an example implementation of the example load identifier 202 and/or the example load identifier 203 of FIG. 2, disclosed herein, to generate PTU data, communicate with the example PRUs 200, and transmit with the transmission gateway 102 of FIGS. 1 and 2. While the example load identifier 202 of FIG. 3 is described in conjunction with the example PTU 104 of FIGS. 1 and 2, the example load identifier 202 may be utilized in any wireless power transfer device. The example load identifier 202 includes an example receiver 300, an example PTU data determiner 302, an example display 304, and an example transmitter 306. The example load determiner 202 communicates with a connected PRU via the example communication links 114, 115, transmits power to a connected PRU via the example power link 112, and communicates with the example transmission gateway 102 via the example gateway link 103.

The example receiver 300 receives instructions from the example transmission gateway 102 via the example gateway link 103 and receives PRU data from the example PRU 200 via the example communication links 114, 115. As described above, the instructions may include instructions associated with alerting a user of the example computing device 110 of an available PTU(s).

The example PTU data determiner 302 generates data corresponding to the PTU (e.g., PTU data). For example, the PTU data determiner 302 may identify an identifier for the PTU, a class of the PTU, a maximum power of the PTU, a timestamp associated with a power-up time of the PTU, a number and/or identity of PRUs associated with the PTU, etc. As described above, the class of the PTU is associated with which types of devices (e.g., mobile devices, tablets, laptops, etc.) the PTU can power. In some examples, a lower class is associated with low power devices with small loads and a higher class is associated with high power devices with large loads. Additionally, the PTU data determiner 302 may monitor a status of the PTU and generate new PTU data when the status of the PTU changes. Alternatively, the PTU data determiner 302 may generate updated PTU data at set time intervals (e.g., after N seconds) and/or based on instructions from the example transmission gateway 102. Additionally, the PTU data determiner 302 may process PRU data based on data received from the example PRU 200 of the example computing device 110. As described above, the PRU data may include an identifier of the PRU, a device type of the PRU, a timestamp, a class of device connected to the PRU, a power of the PRU, a load associated with the PRU, a status of the PRU, a location of the PRU, and/or any data related to the PRU. The example PTU data determiner 302 transmits PTU data and/or PRU data to the example transmission gateway 102 via the example transmitter 306.

The example display 304 receives instructions from the transmission gateway 102 via the example receiver 300. The example display 304 executes the instructions to output an alert to a user of the example computing device 102. The example display 304 may be implemented, for example, by display devices (e.g., a light emitting diode (LED), an organic light emitting diode (OLED), a liquid crystal display, a cathode ray tube display (CRT), a touchscreen, a tactile output device, and/or speakers). In some examples, the example display 304 includes a graphics driver card, a graphics driver chip or a graphics driver processor. In some examples, the example display 304 includes a speaker and/or soundcard.

The example transmitter 306 transmits PTU data and/or PRU data to the example transmission gateway 102 via the transmission gateway link 103. Additionally, the example transmitter 306 provides power to a PRU via the example power link 112 and transmits communication data (e.g., requests, responses, commands, etc.) to a PRU via a communication link (e.g., the example communication links 114, 115). In some examples, the transmitter 306 may transmit PTU data and/or PRU data directly to the second example PTU 106. In some examples, the transmitter 306 may transmit a prompt to the example computing device 110 to access user location preferences.

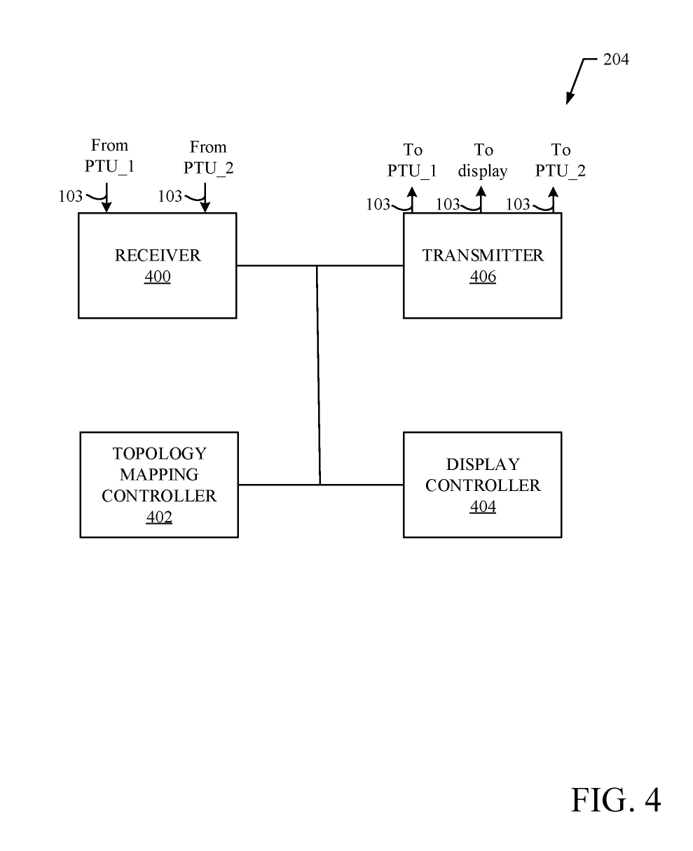

FIG. 4 is a block diagram of an example implementation of the example load balancer 204 of FIG. 2, disclosed herein, to generate a topology mapping of PTUs select available PTUs when a PRU attempts to connect to a PTU that is full (e.g., has no available power resources). While the example load balancer 204 of FIG. 4 is described in conjunction with the example PTUs 104, 106 of FIGS. 1 and 2, the example load balancer 204 may be utilized in any wireless power transfer device. The example load balancer 204 includes an example receiver 400, an example topology mapping controller 402, an example display controller 404, and an example transmitter 406. The example load balancer 204 communicates with a topology of PTUs via the transmission gateway link 103.

The example receiver 400 receives PTU data and PRU data from the example PTUs 104, 106 via the gateway link 103. The example topology mapping controller 402 generates a PTU topology mapping based on the received PTU data and PRU data. For example, when a PTU (e.g., the first example PTU 104) powers up, the PTU 104 transmits PTU data to the load balancer 204. The example topology mapping controller 402 processes the PTU data to add the first example PTU 104 to a PTU topology mapping based on the PTU data. If data related to the first example PTU 104 is updated and/or changed, the first example PTU 104 may send status updates to the example load balancer 204 and the example topology mapping controller 402 may update the PTU topology mapping accordingly. Alternatively, the first example PTU 104 may send status updates to the example load balancer 204 at set time intervals and/or based on requests from the example load balancer 204.

When a PTU (e.g., a full PTU) whose power resources are low (e.g., the first example PTU 104) establishes the example communication link 114 with the example PRU 200 of the example computing device 110, the first example PTU 104 transmits PRU data associated with the example PRU 200 to the example load balancer 204. In some examples, the example topology mapping controller 402 processes the PRU data to determine a class and/or user preferences associated with the example PRU 200. The example topology mapping controller 402 analyzes the topology mapping to identify an available PTU(s) (e.g., the second example PTU 106 of FIGS. 1 and 2) able to power the example PRU 200 of the example computing device 110. The example topology mapping controller 402 selects the second example PTU 106 based on the PTU topology mapping, the PRU data, and/or user preferences.

The example display controller 404 generates instructions for at least one of the first example PTU 104, the second example PTU 106, the example display 116, and/or the example PRU 200 of the example computing device 110 via the first example PTU 104. The example display controller 404 may generate instructions to output text, symbols, flashing lights, images, video, audio, etc. on a display (e.g., the example display 116 of FIG. 2, the example display 304 of FIG. 3, and/or an example display of the example computing device 110). The example display controller 404 instructs the example transmitter 406 to transmit the instructions to at least one of the first example PTU 104, the second example PTU 106, and/or the example display 116 via the example gateway link 103.

While example manners of implementing the example communication forwarder 202 of FIG. 2 is illustrated in the FIG. 3 and the example load balancer 204 of FIG. 2 is illustrated in FIG. 4, elements, processes and/or devices illustrated in FIGS. 3 and 4 may be combined, divided, re-arranged, omitted, eliminated and/or implemented in any other way. Further, the example receiver 300, the example PTU data determiner 302, the example display 304, the example transmitter 306, and/or, more generally, the example communication forwarder 202 of FIG. 3, and/or the example receiver 400, the example topology mapping controller 402, the example display controller 404, the example transmitter 406, and/or more generally, the example load balancer 204 of FIG. 4 may be implemented by hardware, machine readable instructions, software, firmware and/or any combination of hardware, machine readable instructions, software and/or firmware. Thus, for example, any of the example receiver 300, the example PTU data determiner 302, the example display 304, the example transmitter 306, and/or, more generally, the example communication forwarder 202 of FIG. 3, and/or the example receiver 400, the example topology mapping controller 402, the example display controller 404, the example transmitter 406, and/or more generally, the example load balancer 204 of FIG. 4, could be implemented by analog and/or digital circuit(s), logic circuit(s), programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example receiver 300, the example PTU data determiner 302, the example display 304, the example transmitter 306, and/or, more generally, the example communication forwarder 202 of FIG. 3, and/or the example receiver 400, the example topology mapping controller 402, the example display controller 404, the example transmitter 406, and/or more generally, the example load balancer 204 of FIG. 4, is/are hereby expressly defined to include a tangible computer readable storage device or storage disk such as a memory, a digital versatile disk (DVD), a compact disk (CD), a Blu-ray disk, etc. storing the software and/or firmware. Further still, the example communication forwarder 202 of FIG. 3 and/or the example load balancer 204 of FIG. 4 includes elements, processes and/or devices in addition to, or instead of, those illustrated in FIGS. 5-8, and/or may include more than one of any or all of the illustrated elements, processes and devices.

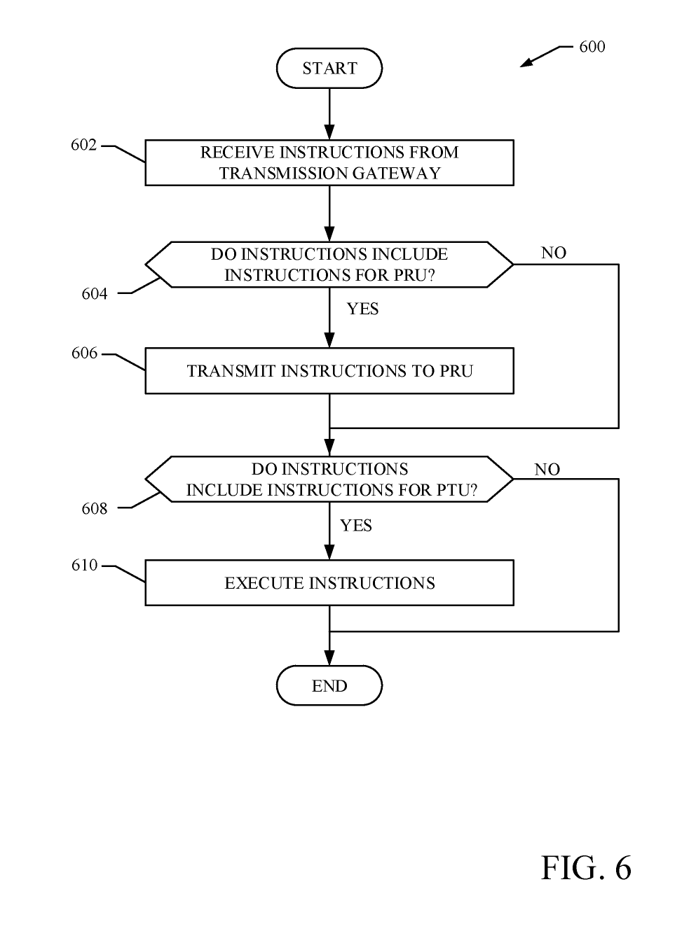

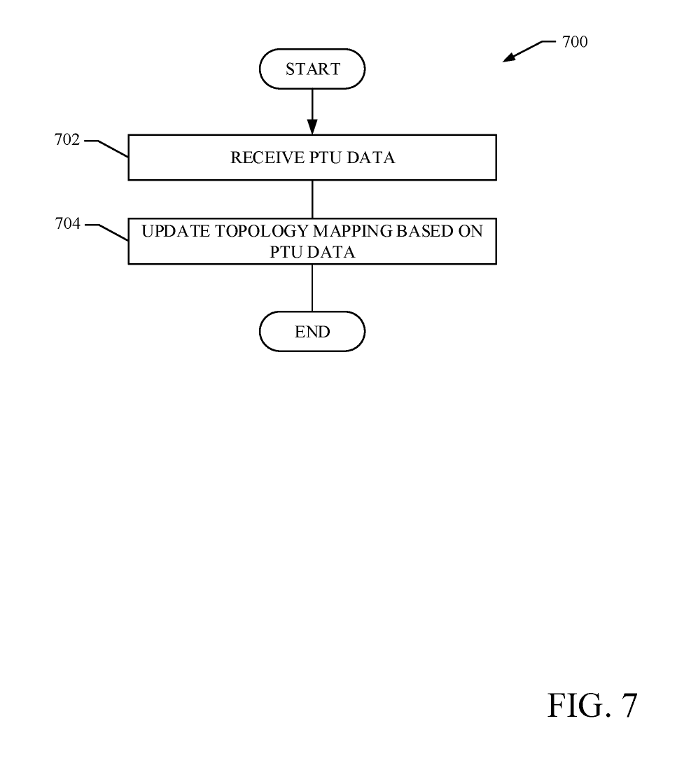

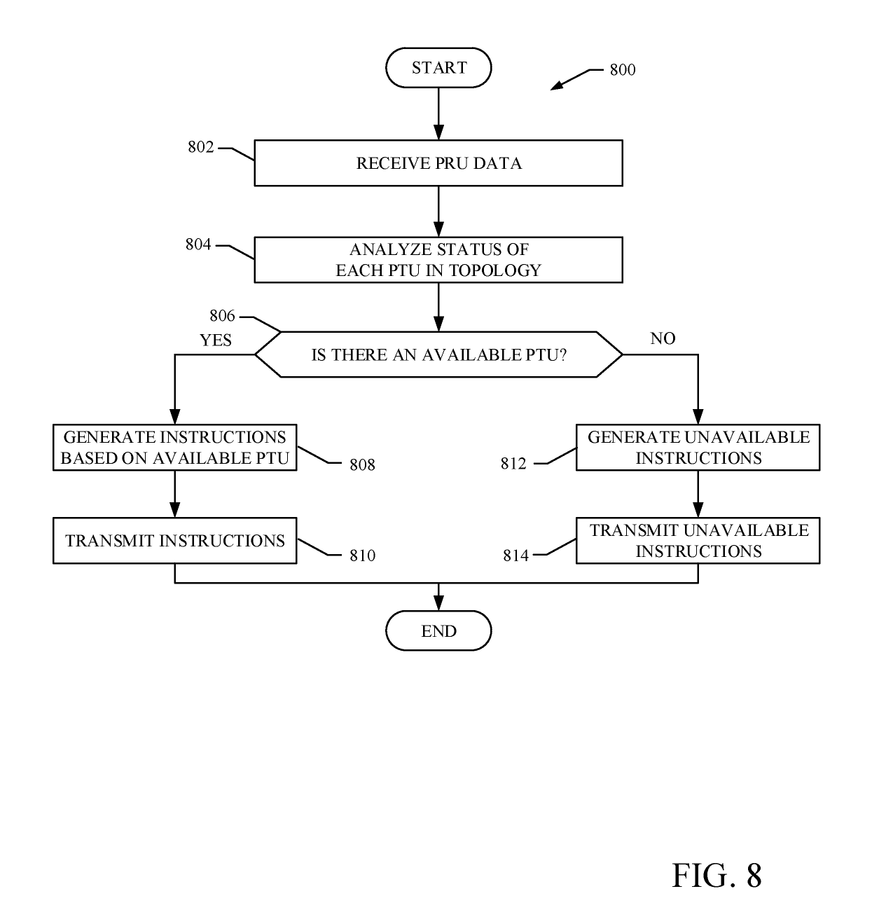

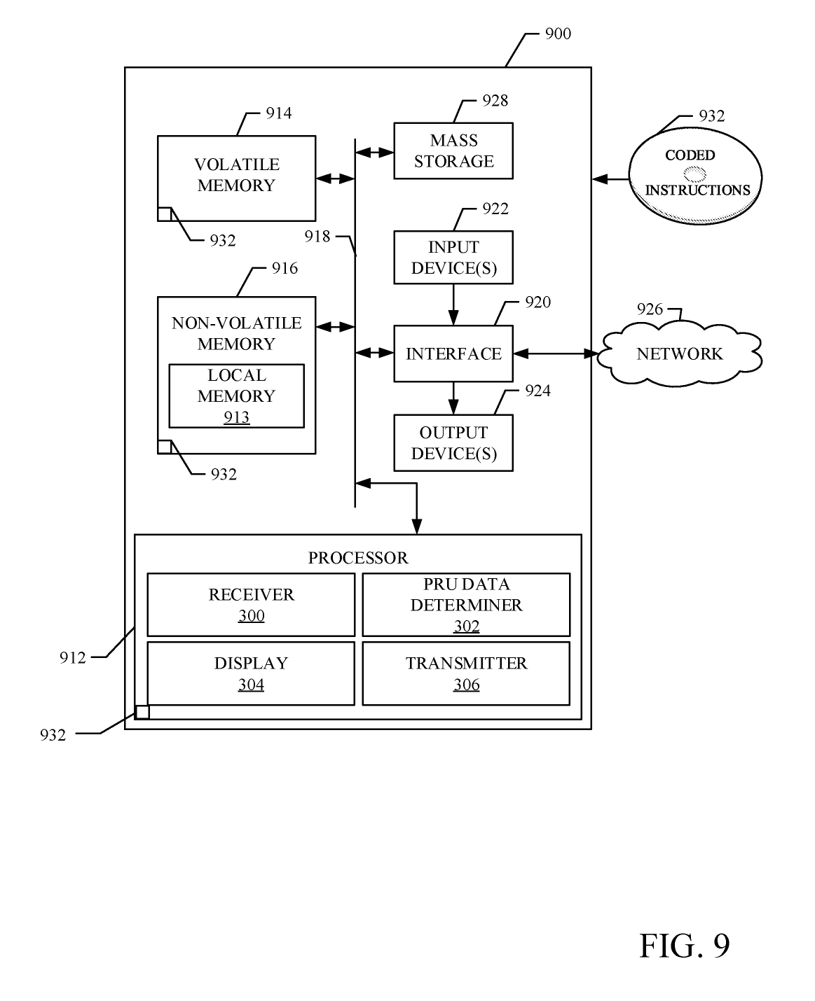

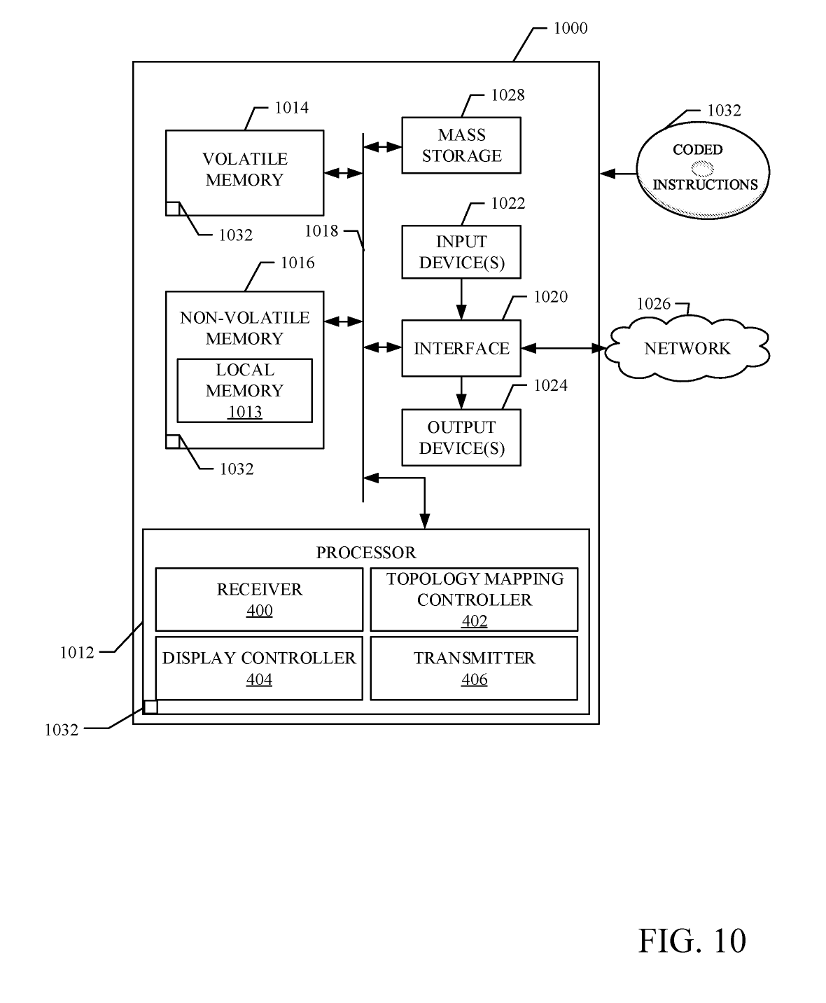

A flowchart representative of example machine readable instructions for implementing the example communication forwarder 202 of FIG. 3 is shown in FIGS. 5-6 and the example load balancer 204 of FIG. 4 is shown in FIGS. 7-8. In the examples, the machine readable instructions comprise a program for execution by a processor such as the processors 912, 1012 shown in the example processor platforms 900, 1000 discussed below in connection with FIGS. 9 and 10. The program may be embodied in machine readable instructions stored on a tangible computer readable storage medium such as a CD-ROM, a floppy disk, a hard drive, a digital versatile disk (DVD), a Blu-ray disk, or a memory associated with the processors 912, 1012, but the entire program and/or parts thereof could alternatively be executed by a device other than the processors 912, 1012 and/or embodied in firmware or dedicated hardware. Further, although the example program is described with reference to the flowcharts illustrated in FIGS. 5-8, many other methods of implementing the example communication forwarder 202 of FIG. 3 and/or the example load balancer 204 of FIG. 4 may alternatively be used. For example, the order of execution of the blocks may be changed, and/or some of the blocks described may be changed, eliminated, or combined.

As mentioned above, the example processes of FIGS. 5-8 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 5-8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 5 is an example flowchart 500 representative of example machine readable instructions that may be executed by the example load identifier 202 of FIG. 5 to transmit PRU data to the example transmission gateway 102 to provide power and/or facilitate the selection of an available PTU in a topology of PTUs.

At block 502, the example receiver 300 receives an advertisement via the example communication link 114 from the example PRU 200 of the example computing device 110. As described above, the advertisement is a message from the example computing device 110 to send power to the computing device 110. In some examples, the advertisement includes PRU data. In some examples, the advertisement establishes communication link 114 and the example PRU 200 transmits PRU data once the communication link 114 has been established.

At block 504, the example PTU data determiner 302 determines PRU data based on the received advertisement. As described above, the PRU data may include an identifier of the example PRU 200, a device type of the PRU 200 and/or computing device 110, a timestamp, a class of the PRU 200 and/or computing device, a power of the PRU, a status of the PRU 200, a location of the PRU 200, and/or any data related to the example PRU 200.

At block 506, the example PTU data determiner 302 determines if the power resources associated with the first example PTU 104 are limited (e.g., low). As shown in FIG. 2, the first example PTU 104 is powering two example computing devices 108. If, for example, the two example computing devices 108 use most/all of the PTU resources, the example PTU data determiner 302 determines that the power resources are limited, and the process continues to block 514. If the example PTU data determiner 302 determines that the power resources are not limited, the PTU data determiner 302 determines if the class of the first example PTU 104 is higher than the class of the PRU 200 of the example computing device 110 (block 508). As described above, the class of the first example PTU 104 identifies which classes of devices can be powered by the first PTU 104. For example, if the class of the PTU 104 is five, the PTU 104 can power all computing devices off class five or lower.

If the example PTU data determiner 302 determines that the class of the first example PTU is greater than or equal to the class of the PRU 200 of the example computing device 110, then the PTU data determiner 302 instructs the example transmitter 306 to transmit power to the example PRU 200 of the example computing device 110 (block 510). Additionally, the example PTU data determiner 302 may instruct the example transmitter 306 to transmit updated PTU data based on a change in power resources and/or load associated with the power connected PRU 200 (block 512). If the example PTU data determiner 302 determines that the class of the first example PTU 104 is less than the class of the PRU 200, the example PTU data determiner 302 instructs the example transmitter 306 to transmit the PRU data to the example transmission gateway 102 (block 514).

FIG. 6 is an example flowchart 600 representative of example machine readable instructions that may be executed by the example load identifier 202 of FIG. 5 and/or the example load identifier 203 to alert a user of the example computing device 110 to the availability and/or location of the second example PTU 106. As described in FIG. 2, the first example PTU 104 has a limited (e.g., below a threshold) amount of power resources and is not able to power the PRU 200 of the example computing device 110 because the first PTU 104 is powering the example computing devices 108. Additionally, the second example PTU 106 is able to power the PRU 200 of the example computing device 110 because the second example PTU 106 is not powering any computing device.

At block 602, the example receiver 300 receives instructions from the example transmission gateway 102. As described above, the instructions may be executed to alert a user of the computing device to the second example PTU 106, and/or other available PTUs, which are available for charging. Alternatively, the example receiver 300 may receive instructions from the second example PTU 106. At block 604, the example PTU data determiner 302 determines if the instructions include instructions to be executed by the example PRU 200 of the example computing device 110. The first example PTU 104 may transmit the instructions to the example PRU 200 to be executed by software on the example computing device 110 to output an alert associated with the second example PTU 106 on a display of the computing device 110. The alert may include audio, video, text, images, symbols, lights, etc. If the example PTU data determiner 302 determines that the instructions include instructions for the example PRU 200, the example PTU data determiner 302 instructs the example transmitter 306 to transmit the instructions to the example PRU 200 via the example communication link 114 (block 606).

At block 608, the example PTU data determiner 302 determines if the instructions include instructions intended for the example display 304 of the first example PTU 104. If the PRU determiner 302 determines that the instructions do include instructions intended for the example display 304, the example display 304 executes the instructions to output an alert to a user of the example computing device 110 (block 610). For example, if the instructions were received by the first load identifier 202 of the first example PTU 104, the display 304 may display text and/or an image, output audio, play a video, light up, etc. to alert the user that the second available PTU 106 is available. If the instructions were received by the second load identifier 203 of the second example PTU 104, the display 304 may display text and/or an image, output audio, play a video, light up, etc. to alert the user to the location of the second example PTU 106 (e.g., to help the user identify the available location).

FIG. 7 is an example flowchart 700 representative of example machine readable instructions that may be executed by the example load balancer 204 of FIG. 4 to generate and maintain a topology of PTUs in a network.

At block 702, the example receiver 400 receives PTU data from a PTU (e.g., the first example PTU 104 and/or the second example PTU 106 of FIGS. 1 and 2). The PTU data may be transmitted at any time from any PTU (e.g., the example PTUs 104, 106) associated with the topology. The PTU data may include an identifier of the PTU, a class of the PTU, a power of the PTU, a maximum power of the PTU, a timestamp of the PTU, a status of the PTU (e.g., how many and/or which PRUs are connected to the PTU), a location of the PTU, and/or any data related to the PTU. The PRU data may include an identifier of the PRU, a device type of the PRU, a timestamp, a class of the PRU, a power of the PRU, a status of the PRU, a location of the PRU, and/or any data related to the PRU.

At block 704, the example topology mapping controller 402 generates and/or updates the topology mapping of PTUs based on the received PTU data. For example, if the PTU data is initial PTU data generated at power up, the example topology mapping controller 402 may update the topology mapping to include the PTU in the topology. In some examples, the PTU data is updated PTU data from a PTU already in the topology. In such examples, the example topology mapping controller 402 updates data (e.g., power resource and/or load data) associated with the PTU in the topology. The topology mapping identifies which PTUs have low power resources (e.g., the first example PTU 104) and which PTUs have high power resources (e.g., the second example PTU 106).

FIG. 8 is an example flowchart 800 representative of example machine readable instructions that may be executed by the example load balancer 204 of FIG. 4 to select an available PTU and alert a user of a computing device based on the available PTU.

At block 802, the example receiver 400 receives PRU data from one of the example PTUs 104, 106 via the example gateway link 103. As described above, when a PRU (e.g., the example PRU 200) attempts to receive power from a PTU (e.g., the first example PTU 104), the example PRU 200 transmits an advertisement to the first example PTU 104 to establish a link (e.g., the example communication link 114). In some examples, the advertisement includes PTU data. In some examples, the PRU 200 transmits PTU data once the example communication link 114 has been established. The PRU data may include an identifier of the PRU, a device type of the PRU, a timestamp, a class of the PRU, a power of the PRU, a status of the PRU, a location of the PRU, and/or any data related to the PRU.

At block 804, the example topology mapping controller 402 analyzes a status of each PTU in the topology mapping (e.g., the topology mapping generated in FIG. 7). The example topology mapping controller 402 may analyze the status to identify a PTU(s) (e.g., the second example PTU 106) available to power the example PRU 200. The example topology mapping controller 402 analyzes the statuses to identify and select an available PTU(s) (e.g., whose power resources are not low) that is currently able to power the example PRU 200 (e.g., the PTU has a class greater than or equal to the example PRU 200).

At block 806, the example topology generator 402 determines if there is an available PTU based on the statuses in the topology based on the mapping. If there is an available PTU (e.g., the second example PTU 106), the example display controller 404 generates instructions based on the second example PTU 106 (e.g., the available PTU) (block 808). The instructions may be sent to one or more of the PTUs in the topology (e.g., the first example PTU 104 and/or the second example PTU 106), the example PRU 200 of the example computing device 110 (e.g., via the first example PTU 104), and/or the example display 116 of FIGS. 1 and 2. For example, the instructions generated for the first example PTU 104 may be executed by the example display 304 (FIG. 3) of the first PTU 104 to output an alert to identify that the first example PTU 104 is full (e.g., the first example PTU 104 does not have available power resources) and/or a message identifying the location and/or identifier of an available PTU (e.g., the second example PTU 106). Additionally or alternatively, the instructions generated for the second example PTU 106 may be executed by the example display 304 (FIG. 3) of the second example PTU 106 to light up to alert a user to the location of the second example PTU 106. Additionally or alternatively, the instructions generated for the example PRU 200 may be executed by the example computing device 110 to output an alert (e.g., text, image, video, audio, etc.) on a display of the computing device 110 to identify the location of the second example PTU 106. Additionally or alternatively, the instructions generated for the example display 116 may be executed to 200 to output an alert (e.g., text, image, video, audio, etc.) to identify the location of the second example PTU 106. At block 810, the example display controller 404 instructs the example transmitter 406 to transmit the instructions to at least one of the first example PTU 104, the second example PTU 106, the example PRU 200, and/or the example display 116.

If there are no available PTUs, the example display controller 404 generates unavailable instructions (block 812). The unavailable instructions may be sent to one or more of the PTUs in the topology (e.g., the first example PTU 104 and the second example PTU 106), the example PRU 200 of the example computing device 110 (e.g., via the first example PTU 104), and/or the example display 116 of FIG. 2. The unavailable instructions may be executed by the example PTUs 104, 106, the example computing device 110, and/or the example display 116 to output an alert (e.g., text, image, video, audio, etc.) indicating that there are no PTUs currently available to power the example PRU 200. At block 814, the example display controller 404 instructs the example transmitter 406 to transmit the instruction to at least one of the first example PTU 104, the second example PTU 106, the example PRU 200, and/or the example display 116.

FIG. 9 is a block diagram of an example processor platform 900 capable of executing the instructions of FIGS. 5-6 to implement the example communication forwarder 202 of FIGS. 2 and 3. The processor platform 900 can be, for example, a server, a personal computer, a mobile device (e.g., a cell phone, a smart phone, a tablet such as an iPad™), a personal digital assistant (PDA), an Internet appliance, or any other type of computing device.

The processor platform 900 of the illustrated example includes a processor 912. The processor 912 of the illustrated example is hardware. For example, the processor 912 can be implemented by integrated circuits, logic circuits, microprocessors or controllers from any desired family or manufacturer.

The processor 912 of the illustrated example includes a local memory 913 (e.g., a cache). The example processor 912 of FIG. 9 executes the instructions of FIGS. 5-6 to implement the example receiver 300, the example PTU data determiner 302, the example display 304, and/or the example transmitter 306 of FIG. 3 to implement the example communication forwarder 202. The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a clock controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, a sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives.

The coded instructions 932 of FIG. 9 may be stored in the mass storage device 928, in the volatile memory 914, in the non-volatile memory 916, and/or on a removable tangible computer readable storage medium such as a CD or DVD.

FIG. 10 is a block diagram of an example processor platform 1000 capable of executing the instructions of FIGS. 7-8 to implement the example load balancer 204 of FIGS. 2 and 4. The processor platform 1000 can be, for example, a server, a personal computer, a mobile device (e.g., a cell phone, a smart phone, a tablet such as an iPad™), a personal digital assistant (PDA), an Internet appliance, or any other type of computing device.

The processor platform 1000 of the illustrated example includes a processor 1012. The processor 1012 of the illustrated example is hardware. For example, the processor 1012 can be implemented by integrated circuits, logic circuits, microprocessors or controllers from any desired family or manufacturer.

The processor 1012 of the illustrated example includes a local memory 1013 (e.g., a cache). The example processor 1012 of FIG. 10 executes the instructions of FIGS. 7-8 to implement the example receiver 400, the example topology mapping controller 402, the example display controller 404, and/or the example transmitter 406 of FIG. 4 to implement the example load balancer 204. The processor 1012 of the illustrated example is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a clock controller.

The processor platform 1000 of the illustrated example also includes an interface circuit 1020. The interface circuit 1020 may be implemented by any type of interface standard, such as an Ethernet interface, a universal serial bus (USB), and/or a PCI express interface.

In the illustrated example, one or more input devices 1022 are connected to the interface circuit 1020. The input device(s) 1022 permit(s) a user to enter data and commands into the processor 1012. The input device(s) can be implemented by, for example, a sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, and/or speakers). The interface circuit 1020 of the illustrated example, thus, typically includes a graphics driver card, a graphics driver chip or a graphics driver processor.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, RAID systems, and digital versatile disk (DVD) drives.

The coded instructions 1032 of FIG. 10 may be stored in the mass storage device 1028, in the volatile memory 1014, in the non-volatile memory 1016, and/or on a removable tangible computer readable storage medium such as a CD or DVD.

From the foregoing, it would be appreciated that the above disclosed method, apparatus, and articles of manufacture generate a PTU topology mapping and, when a computing device attempts to receive power from a full PTU, alert a user of the computing device to the location of an available PTU. Using the examples disclosed herein, a status of a PTU in a topology mapping of PTUs can be generated and maintained by a transmission gateway. When a computing device attempts to receive power from a full PTU, the PTU can communicate with the transmission gateway to determine an available PTU. The transmission gateway selects an available PTU and sends instructions to a display to alert the user to the location of the available PTU.

Conventional PRUs operate independently of each other. Thus, when a computing device attempts to receive power from a full PTU, the PTU does not identify an available PTU. Examples disclosed herein alleviate such problems by utilizing a transmission gateway to generate a topology mapping of connected PTUs in a network. The transmission gateway can identify available PTUs based on status updates from the PTUs and alert a user of the computing device to the availability and/or location of the available PTU.

Example 1 is a method comprising receiving data related to a power receiving unit (PRU) from a first power transmitting unit (PTU), identifying a second PTU based on the data, and transmitting an alert corresponding to the second PTU to at least one of the first PRU, the first PTU, the second PTU, or a display.

Example 2 includes the subject matter of example 1, wherein the data was transmitted to the first PTU from the PRU.

Example 3 includes the subject matter of example 1, wherein the first PTU is unable to provide power to the PRU.

Example 4 includes the subject matter of example 1, wherein the data includes at least one of an identifier of the PRU, a device type of the PRU, a timestamp, a class of the PRU, a power of the PRU, a status of the PRU, or a location of the PRU.

Example 5 includes the subject matter of examples 1, 2, 3, or 4, further including generating a topology mapping including the first PTU and the second PTU, the topology mapping including second data related to the first PTU and third data related to the second PTU.

Example 6 includes the subject matter of example 5, wherein the second data includes at least one of an identifier of the first PTU, a class of the first PTU, a power of the first PTU, a maximum power of the first PTU, a timestamp associated with power-up of the first PTU, a status of the first PTU, or a physical location of the first PTU, and the third data includes at least one of an identifier of the second PTU, a class of the second PTU, a power of the second PTU, a maximum power of the second PTU, a timestamp associated with power-up of the second PTU, a status of the second PTU, or a physical location of the second PTU.

Example 7 includes the subject matter of example 5, wherein the identifying of the second PTU is further based on the topology mapping.

Example 8 includes the subject matter of examples 1 or 5, wherein the second PTU is able to provide power to the PRU.

Example 9 includes the subject matter of example 5, wherein the alert causes at least one of the first PRU, the first PTU, the second PTU, or the display to output at least one of audio, video, an image, text, symbols, or light.

Example 10 is an apparatus comprising a receiver to receive data related to a power receiving unit (PRU) from a first power transmitting unit (PTU), a topology mapping controller to identify a second PTU based on the data, and a transmitter to transmit an alert corresponding to the second PTU to at least one of the first PRU, the first PTU, the second PTU, or a display.

Example 11 includes the subject matter of example 10, wherein the data was transmitted to the first PTU from the PRU.

Example 12 includes the subject matter of example 10, wherein the first PTU is unable to provide power to the PRU.

Example 13 includes the subject matter of example 10, wherein the data includes at least one of an identifier of the PRU, a device type of the PRU, a timestamp, a class of the PRU, a power of the PRU, a status of the PRU, or a location of the PRU.

Example 14 includes the subject matter of examples 10, 11, 12, or 13, wherein the topology mapping controller is to generate a topology mapping including the first PTU and the second PTU, the topology mapping including second data related to the first PTU and third data related to the second PTU.

Example 15 includes the subject matter of example 14, wherein the second data includes at least one of an identifier of the first PTU, a class of the first PTU, a power of the first PTU, a maximum power of the first PTU, a timestamp associated with power-up of the first PTU, a status of the first PTU, or a physical location of the first PTU, and the third data includes at least one of an identifier of the second PTU, a class of the second PTU, a power of the second PTU, a maximum power of the second PTU, a timestamp associated with power-up of the second PTU, a status of the second PTU, or a physical location of the second PTU.

Example 16 includes the subject matter of example 14, wherein the topology mapping controller is to further identify the second PTU based on the topology mapping.

Example 17 includes the subject matter of examples 10 or 14, wherein the second PTU is able to provide power to the PRU.

Example 18 includes the subject matter of example 14, wherein the alert causes at least one of the first PRU, the first PTU, the second PTU, or the display to output at least one of audio, video, an image, text, symbols, or light.

Example 19 includes a computer readable medium comprising instructions that, when executed cause a machine to at least receive data related to a power receiving unit (PRU) from a first power transmitting unit (PTU), identify a second PTU based on the data, and transmit an alert corresponding to the second PTU to at least one of the first PRU, the first PTU, the second PTU, or a display.

Example 20 includes the subject matter of example 19, wherein the data was transmitted to the first PTU from the PRU.

Example 21 includes the subject matter of example 19, wherein the first PTU is unable to provide power to the PRU.

Example 22 includes the subject matter of example 19, wherein the data includes at least one of an identifier of the PRU, a device type of the PRU, a timestamp, a class of the PRU, a power of the PRU, a status of the PRU, or a location of the PRU.

Example 23 includes the subject matter of examples 19, 20, 21 or 22, wherein the instructions cause the machine to generate a topology mapping including the first PTU and the second PTU, the topology mapping including second data related to the first PTU and third data related to the second PTU.

Example 24 includes the subject matter of example 23, wherein the second data includes at least one of an identifier of the first PTU, a class of the first PTU, a power of the first PTU, a maximum power of the first PTU, a timestamp associated with power-up of the first PTU, a status of the first PTU, or a physical location of the first PTU, and the third data includes at least one of an identifier of the second PTU, a class of the second PTU, a power of the second PTU, a maximum power of the second PTU, a timestamp associated with power-up of the second PTU, a status of the second PTU, or a physical location of the second PTU.

Example 25 includes the subject matter of example 23, wherein the instructions cause the machine to further identify the second PTU based on the topology mapping.

Example 26 includes the subject matter of examples 19 or 23, wherein the second PTU is able to provide power to the PRU.

Example 27 includes the subject matter of example 23, wherein the alert causes at least one of the first PRU, the first PTU, the second PTU, or the display to output at least one of audio, video, an image, text, symbols, or light.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method comprising:
receiving data related to a power receiving unit (PRU) from a first power transmitting unit (PTU);
identifying a second PTU based on the data; and
transmitting an alert corresponding to the second PTU to at least one of the first PRU, the first PTU, the second PTU, or a display.

2. The method of claim 1, wherein the data was transmitted to the first PTU from the PRU.

3. The method of claim 1, wherein the first PTU is unable to provide power to the PRU.

4. The method of claim 1, wherein the data includes at least one of an identifier of the PRU, a device type of the PRU, a timestamp, a class of the PRU, a power of the PRU, a status of the PRU, or a location of the PRU.

5. The method of claim 1, further including generating a topology mapping including the first PTU and the second PTU, the topology mapping including second data related to the first PTU and third data related to the second PTU.

6. The method of claim 5, wherein:
the second data includes at least one of an identifier of the first PTU, a class of the first PTU, a power of the first PTU, a maximum power of the first PTU, a timestamp associated with power-up of the first PTU, a status of the first PTU, or a physical location of the first PTU; and
the third data includes at least one of an identifier of the second PTU, a class of the second PTU, a power of the second PTU, a maximum power of the second PTU, a timestamp associated with power-up of the second PTU, a status of the second PTU, or a physical location of the second PTU.

7. The method of claim 5, wherein the identifying of the second PTU is further based on the topology mapping.

8. The method of claim 1, wherein the second PTU is able to provide power to the PRU.

9. The method of claim 5, wherein the alert causes at least one of the first PRU, the first PTU, the second PTU, or the display to output at least one of audio, video, an image, text, symbols, or light.

10. An apparatus comprising:
a receiver to receive data related to a power receiving unit (PRU) from a first power transmitting unit (PTU);
a topology mapping controller to identify a second PTU based on the data; and
a transmitter to transmit an alert corresponding to the second PTU to at least one of the first PRU, the first PTU, the second PTU, or a display.

11. The apparatus of claim 10, wherein the data was transmitted to the first PTU from the PRU.

12. The apparatus of claim 10, wherein the first PTU is unable to provide power to the PRU.

13. The apparatus of claim 10, wherein the data includes at least one of an identifier of the PRU, a device type of the PRU, a timestamp, a class of the PRU, a power of the PRU, a status of the PRU, or a location of the PRU.

14. The apparatus of claim 10, wherein the topology mapping controller is to generate a topology mapping including the first PTU and the second PTU, the topology mapping including second data related to the first PTU and third data related to the second PTU.

15. The apparatus of claim 14, wherein:
the second data includes at least one of an identifier of the first PTU, a class of the first PTU, a power of the first PTU, a maximum power of the first PTU, a timestamp associated with power-up of the first PTU, a status of the first PTU, or a physical location of the first PTU; and
the third data includes at least one of an identifier of the second PTU, a class of the second PTU, a power of the second PTU, a maximum power of the second PTU, a timestamp associated with power-up of the second PTU, a status of the second PTU, or a physical location of the second PTU.

16. The apparatus of claim 14, wherein the topology mapping controller is to further identify the second PTU based on the topology mapping.

17. The apparatus of claim 10, wherein the second PTU is able to provide power to the PRU.

18. The apparatus of claim 14, wherein the alert causes at least one of the first PRU, the first PTU, the second PTU, or the display to output at least one of audio, video, an image, text, symbols, or light.

19. A computer readable medium comprising instructions that, when executed cause a machine to at least:
receive data related to a power receiving unit (PRU) from a first power transmitting unit (PTU);
identify a second PTU based on the data; and
transmit an alert corresponding to the second PTU to at least one of the first PRU, the first PTU, the second PTU, or a display.

20. The computer readable medium of claim 19, wherein the data was transmitted to the first PTU from the PRU.
